(19) United States
(12) Patent Application Publication
(10) Pub. No.: US 2010/0034295 A1
(43) Pub. Date: Feb. 11, 2010

(54) METHOD AND SYSTEM FOR PSI HANDLING TO IMPROVE CHANNEL CHANGE TIME

(76) Inventors: Wade Wan, Orange, CA (US); Rajesh Mamidwar, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/189,022

(22) Filed: Aug. 8, 2008

(51) Int. Cl. H04N 11/02

(52) U.S. Cl. 375/240.26; 375/E07.026

(57) ABSTRACT

Aspects of a method and system for PSI handling to improve channel change time. A MPEG-2 transport bitstream (TS) received using a MPEG-2 decoding system may comprise program specific information used for a desired program reception. In instances where signal acquisition or a channel change occurs, the received MPEG-2 TS may be gated or buffered for processing at least a portion of the PSI. The portion of the PSI in the received MPEG-2 TS may be detected and extracted from the buffered MPEG-2 TS during the PSI processing. After the PSI processing, the buffered MPEG-2 TS may be split into video, and/or audio, and/or data components based on the extracted PSI and may be decoded, accordingly. In instances where signal acquisition or a channel change does not occur, the TS buffering may be bypassed.

### CROSS-REFERENCE TO RELATED APPLICATIONS/INCORPORATION BY REFERENCE

Not applicable

### FIELD OF THE INVENTION

Certain embodiments of the invention relate to signal processing for video coding systems. More specifically, certain embodiments of the invention relate to a method and system for PSI handling to improve channel change time.

### BACKGROUND OF THE INVENTION

MPEG-2 Systems is today's dominant systems layer standard because it enables the delivery of high quality transmission of multiple programs in a single digital signal and paves the way for the introduction of high definition television (TV).

An output stream of an audio or video encoder is called an elementary stream (ES). The length of an ES may be variable and may be as long as the program itself. Each elementary stream may be broken into a plurality of convenient-sized data blocks in a packetized elementary stream (PES). For transmission and digital broadcasting, several programs and their associated PES may be multiplexed into a single transport stream (TS). An TS further subdivides PES packets into short fixed-size packets. Each packet carries a packet identifier code (PID), which plays a key role in the operation of the TS. Packets in the same elementary stream all have the same PID. This may enable a MPEG-2 decoder (or demultiplexer) to select the elementary stream(s) it wants and filter out unwanted ESs based on their corresponding PIDs.

When forming the TS, additional packets, which may comprise information needed to receive and/or demultiplex the TS, are inserted. The additional packets are collectively referred to as program specific information (PSI). The PSI may comprise of a set of tables which may be required for demultiplexing the received TS and sorting out which PIDs belong to which programs in the received TS. The PSI may comprise a Program Association Table (PAT) and one or more Program Map Tables (PMT). The PAT lists every program in the received TS. Each entry in the PAT points to a particular Program Map Table (PMT) that lists corresponding elementary streams making up each program. To identify a desired PID to demultiplex a particular PES, the MPEG-2 decoder (or demultiplexer) may search for the PAT for all programs in the received TS. Each program may be associated with one or more PIDs, one for each PES, which corresponds to a particular PMT carried as a separate PSI section. The PSI is usually sent periodically or so to ensure that consumers may access desired programs after switching on, or after switching to a new TS. It also ensures that consumer receivers are updated with any program changes.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for PSI handling to improve channel change time, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary MPEG-2 decoding system for handling PSI to improve channel change time, in accordance with an embodiment of the invention.

FIG. 2 is a diagram illustrating an exemplary MPEG-2 PSI table sequence in an MPEG-2 decoding system, in accordance with an embodiment of the invention.

FIG. 3 is a diagram illustrating an exemplary MPEG-2 de-multiplexer, in accordance with an embodiment of the invention.

FIG. 4 is a diagram illustrating an exemplary PSI processing sequence in an MPEG-2 decoding system, in accordance with an embodiment of the invention.

FIG. 5 is an exemplary flow diagram illustrating PSI processing, in accordance with an embodiment of the invention.

### DETAILED DESCRIPTION OF THE INVENTION

Certain embodiments of the invention may be found in a method and system for PSI handling to improve channel change time. Various aspects of the invention may enable receiving and processing of a MPEG-2 transport bitstream (TS) by a MPEG-2 decoding system. The received MPEG-2 TS may comprise PSI (program specific information), which may be used for a desired program reception. In instances where signal acquisition or a channel change occurs, the received MPEG-2 TS may be gated and/or buffered to process at least a portion of the PSI in the received MPEG-2 TS. The PSI processing may comprise PSI detection and extraction in the buffered MPEG-2 TS data. After the PSI processing, the buffered MPEG-2 TS may be communicated to a transport engine, which may be operable to split the buffered MPEG-2 TS into video, audio, and/or data components based on the extracted PSI. A portion of the buffered MPEG-2 TS indicated in the extracted PSI for a desired program may be decoded, accordingly. In instances where signal acquisition or a channel change does not occur, the TS buffering may be bypassed.

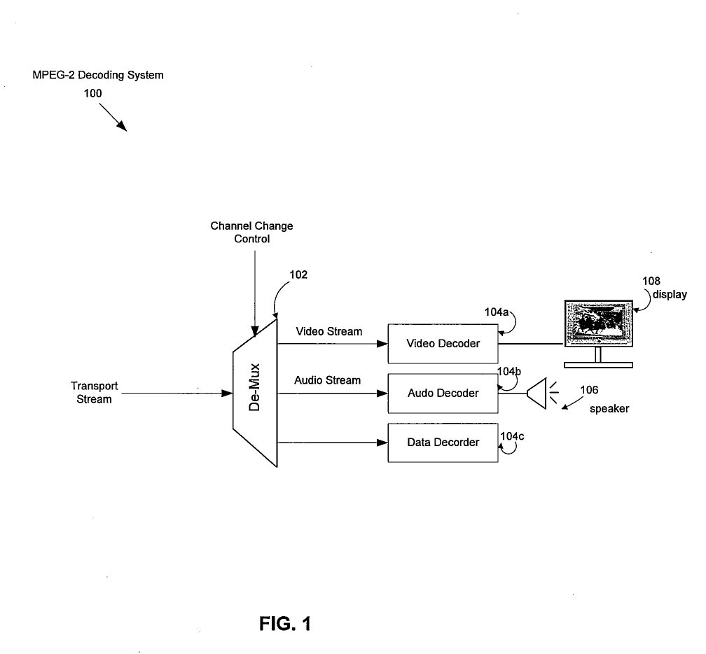

FIG. 1 is a block diagram illustrating an exemplary MPEG-2 decoding system for handling PSI to improve channel change time, in accordance with an embodiment of the invention. Referring to FIG. 1, there is shown a MPEG-2 decoding system 100 comprising a demultiplexer (de-mux) 102, a plurality of decoders, of which a video decoder 104a, an audio decoder 104b, and a data decoder 104c are illustrated, a speaker 106, and a display 108.

The de-mux 102 may comprise suitable logic, circuitry and/or code that may be enabled to receive a MPEG-2 transport stream and extract individual program streams in the received MPEG-2 TS. The de-mux 102 may be operable to detect and extract Program specific information (PSI) tables from the received MPEG-2 TS, and the resulting extracted information may be used to determine particular programs that may be desired. The received MPEG-2 TS may be demultiplexed by the de-mux 102 into video, audio and data components based on corresponding PIDs indicated in the PSI tables such as a PAT and, one or more PMTs. The de-mux 102 may select one or more particular elementary stream(s) of a desired program and reject the remainder based on the extracted PSI tables. Although PSI tables for the received MPEG-2 TS are transmitted periodically, inherent delays on PSI processing such as the PSI detection and/or extraction for the reception of the received MPEG-2 TS may cause a longer channel change time. In this regard, in order to reduce the channel change time, wherever a channel change and/or signal acquisition, the de-mux 102 may be enabled to buffer the received MPEG-2 TS and corresponding PSI processing may be performed on the buffered MPEG-2 TS data. The detected PSI tables may be stored inside the de-mux 102 and may be used for a fast channel change.

The video decoder 104a may comprise suitable logic, circuitry and/or code that may be enabled to decompress an individual video ES. The video decoder 104a may be enabled to obtain an individual compressed and coded video ES to recover a targeted video program identified by corresponding PID from the detected PSI tables. The recovered targeted video program may be present at the display 108.

The audio decoder 104b may comprise suitable logic, circuitry and/or code that may be enabled to decompress an individual audio ES. The audio decoder 104b may be enabled to obtain an individual compressed and coded audio ES to recover a targeted audio program identified by a corresponding PID extracted from the detected PSI tables. The recovered target audio program may be present at the speaker 106.

The data decoder 104c may comprise suitable logic, circuitry and/or code that may be enabled to decompress an individual data ES. The data decoder 104c may be enabled to obtain an individual compressed and coded data ES to recover a targeted data such as teletext data identified by corresponding PID from the detected PSI tables.

In operation, a MPEG-2 transport bitstream (TS) comprising program specific information (PSI) may be received via the MPEG-2 decoding system 100. In instances where a signal acquisition or a channel change may be signaled via, for example, a channel change control signal, the de-mux 102 may be enabled to detect the PSI for available programs in the received MPEG-2 TS. To ensure a fast channel change or a fast signal acquisition, the de-mux 102 may be enabled to buffer the received MPEG-2 TS and perform PSI processing on the buffered MPEG-2 TS. The received MPEG-2 TS may then be parsed into video, audio and data components by identifying corresponding PIDs in the detected PSI. The parsed video, audio, and data components may be communicated to the video decoder 104a, the audio decoder 104b, and the data decoder 104c, respectively. The decoded components such as the decoded video components and the decoded audio components may be presented at the display 108 and the speaker 106, respectively.

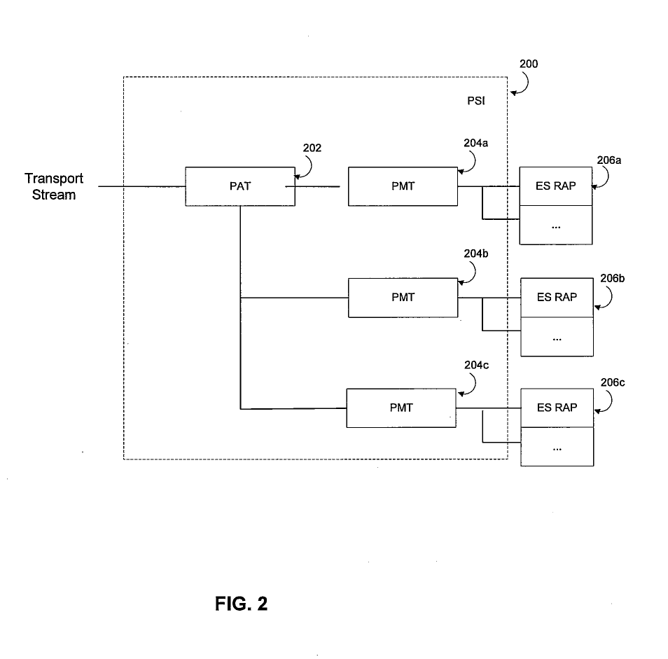

FIG. 2 is a diagram illustrating an exemplary MPEG-2 PSI table sequence in an MPEG-2 decoding system, in accordance with an embodiment of the invention. Referring to FIG. 2, there is shown a PSI 200 and one or more ES RAP (elementary stream random access point), of which an ES RAP 206a, an ES RAP 206b, and an ES RAP 206c. The PSI 200 may comprise a PAT 202, one or more PMT such as a PMT 202a, a PMT 202b, and a PMT 204c. For ease of description, additional and/or optional PSI tables such as a CAT (Conditional Access Table) are not shown.

The PSI 200 may comprise suitable logic and/or code that may be utilized by the MPEG-2 decoding system 100 to demultiplex a received MPEG-2 TS and identify which PIDs belong to which programs. The PSI 200 may comprise a set of tables such as the PAT 202 and plural PMT.

The PAT 202 may comprise suitable code and may be the master PSI table with a determined PID value such as 0. The PAT 202 may be used to identify programs in a received MPEG-2 TS. In instances where the PAT 402 may not be found or detected in the received MPEG-2 TS, then no programs in the received TS may be found and/or presented. The received MPEG-2 TS may comprise one or more programs. Each program may require its own PMT such as the PMT 204a with a unique PID value indicated in the PAT 202.

A PMT such as the PMT 204a may comprise suitable code and may describe a relation between a program in the received TS and one or more elementary streams making up the program. The information in a PMT such as the PMT 204a may be used to indirectly specify a set of packets that may configure the program for reception. Packets in the same elementary stream of a particular program may have the same PID indicated in the PMT 204a. An ES of the received MPEG-2 TS may be selected or rejected in the MPEG-2 decoding system 100 based on PID information indicated in a corresponding PMT such as the PMT 204a.

An ES RAP such as the ES RAP 206a may define a first point for a particular program where decoding should begin. The ES RAP 206a may be followed by one or more ESs making up the program.

The PSI 200 of the received MPEG-2 TS may be transmitted periodically to aid with program selection. In order to determine which audio and/or video PIDs may contain the contents of the selected program, a PMT such as the PMT 204a may be decoded. In order to determine which PID may contain the desired program's PMT such as the PMT 204a, the PAT 202 may be decoded. The PSI 200 may be sent at a fast rate to ensure that program selection occurs in an expedited manner. However, the PSI 200 may not be transmitted too frequently in order to reduce transmission overhead. For example, the PSI 200 may be transmitted, for example, every 2500 PES packets.

In some systems, the PSI 200 may not be detected and/or extracted in time due to various PSI processing delays caused by, for example, PAT detection/extraction and/or PMT detection/extraction. As a result, a channel change or a signal acquisition may be delayed for one or more subsequent PSI transmission cycles. For example, by the time the de-mux 102 may determine the PAT 202 of the received MPEG-2 TS, the first desired PMT such as the PMT 204a may be already gone. In order to identify one or more particular ESs of a desired program, the de-mux 102 may have to wait until another instance of the PMT 204a. A similar problem may occur when locating a desired ES RAP indicated in a selected PMT 204a. For example, by the time the de-mux 102 may determine the PAT 202 and/or the PMT 204a of the received MPEG-2 TS, the first desired ES RAP such as the ES RAP 206a indicated in, for example, the PMT 204a may have already passed. In order to identify the ES RAP 206a, the de-mux 102 may have to wait until another instance of the ES RAP 206a. In this regard, in order to reduce a channel change time, the de-mux 102 may be enabled to buffer at least a portion of the received MPEG-2 TS and the corresponding PSI processing may be performed on the buffered MPEG-2 TS data. The detected PSI tables may be used to enable a fast channel change and/or a program acquisition.

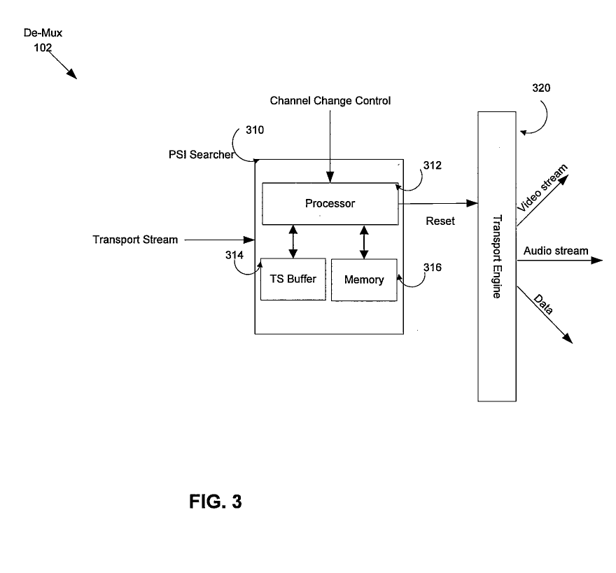

FIG. 3 is a diagram illustrating an exemplary MPEG-2 de-multiplexer, in accordance with an embodiment of the invention. Referring to FIG. 3, there is shown a de-mux 102 comprising a PSI searcher 310 and a transport engine 320. The PSI searcher 210 may comprise a processor 312, a TS buffer 314, and a memory 316.

The PSI searcher 310 may comprise suitable logic, circuitry and/or code that may detect and extract the PSI tables such as the PAT 202 and one or more PMTs such as the PMT 204a from a received MPEG-2 TS. The received MPEG-2 TS may be initially buffered at the PSI searcher 310 and fed to the transport engine 320 after PSI processing.

The processor 312 may comprise suitable logic, circuitry and/or code that may be enabled to perform a PSI processing for the received MPEG-2 TS in the MPEG-2 decoding system 100. The processor 312 may be communicatively coupled to the TS buffer 314 and the memory 316, respectively. In accordance with an embodiment of the invention, the processor 312 may be configured to detect and/or extract the PSI 200 of the received MPEG-2 TS via various algorithms. The processor 312 may be programmed to perform PSI processing on the buffered MPEG-2 TS from the TS buffer 314. In addition, the processor 312 may communicate with the transport engine 320 to reset the transport engine 320 using the extracted PSI 200 and to feed the buffered MPEG-2 TS through the transport engine 320.

The TS buffer 314 may comprise suitable logic, circuitry and/or code that may enable buffering incoming MPEG-2 TSs. The TS buffer 314 may be managed based on, for example, QoS of targeted programs and/or the PSI transmission period.

The memory 316 may comprise suitable logic, circuitry, and/or code that may enable storing of information such as executable instructions and data that may be utilized by the processor 312. The executable instructions may comprise various algorithms that may be enabled to search for and/or otherwise identity PSI in a given MPEG-2 TS. The data may comprise detected PSI information associated with the received MPEG-2 TS. The memory 316 may comprise RAM, ROM, low latency nonvolatile memory such as flash memory and/or other suitable electronic data storage.

The transport engine 320 may comprise suitable logic, circuitry and/or code that may enable filtering a MPEG-2 TS on the PID value. The transport engine 320 may acquire the individual program streams and split out the elementary data streams into video, audio, and data components. The transport engine 320 may be enabled to filter out unwanted or undesired MPEG data by discarding MPEG packets that may not have a PID indicated in the detected PSI 200.

In operation, a MPEG-2 transport bitstream may be received using a MPEG-2 decoding system such as the one described in FIG. 1. The PSI 200 associated with the received MPEG-2 TS may be used for reception. In instances where a channel change may be required via, for example, the channel change control signal, the processor 312 may enable the TS buffer 314 to buffer the received MPEG-2 TS for PSI processing. The processor 312 may search for the PSI 200 in the buffered MPEG-2 TS. In instances where the PSI 200 such as the PAT 302 and a plurality of PMTs such as the PMT 204a may be detected, the detected PSI 200 may be communicated to the transport engine 320 to reset the transport engine 320. The transport engine 320 may be operable to determine the programs based on the corresponding PIDs indicated in the PSI 200, and accordingly parse the received MPEG-2 TS into video, audio, and data components.

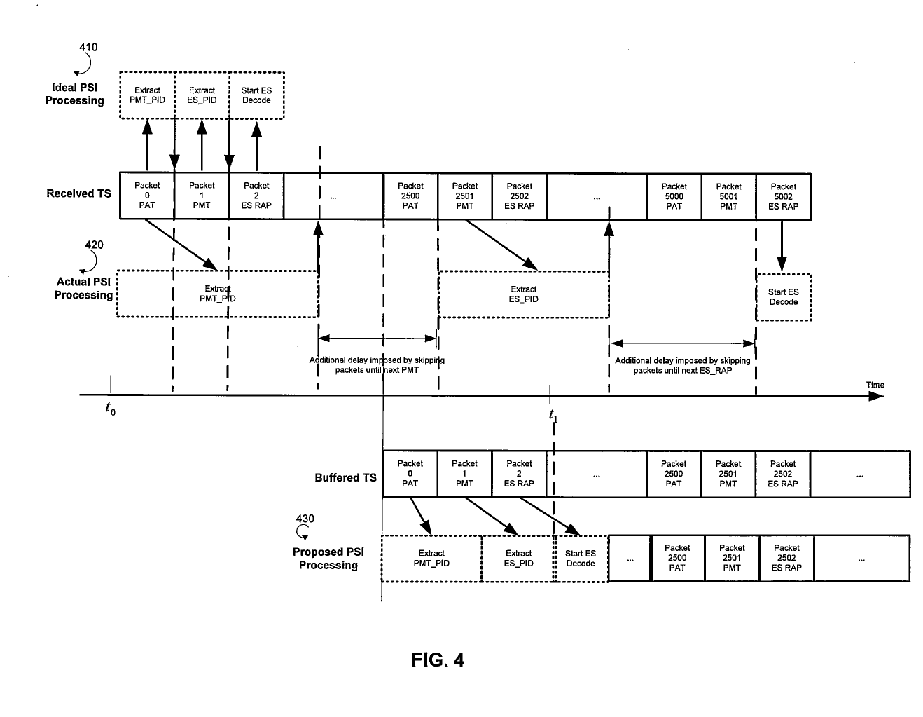

FIG. 4 is diagram illustrating an exemplary PSI processing sequence in an MPEG-2 decoding system, in accordance with an embodiment of the invention. Referring to FIG. 4, there is shown an ideal PSI processing 410, an actual PSI processing 420, and a proposed PSI processing 430.

It may be assumed in this example that a packet sequence of a received MPEG-2 TS may be structured as a PAT in the very first packet (packet 0), a PMT in the second packet (packet 1), an ES RAP in the third packet (Packet 2), and then followed by one or more ESs of a program indicated in the PMT, respectively. The PAT, the PMT, and the ES_RAP may be transmitted periodically such as, for example, every 2500 packets, in the received TS.

Referring to the ideal PSI processing 410, a MPEG-2 TS may be received using a MPEG-2 decoding system such as the one described in FIG. 1. The de-mux 102 may be enabled to perform PSI processing to detect and extract associated PSI 200 such as, for example, the PAT 202 and the PMT 204a, of the received MPEG-2 TS. The de-mux 102 may be enabled to search for the PAT 202 in the first packet of a corresponding packet sequence of the received MPEG-2 TS. In instances where the PAT 202 may be found, the PID of a desired program such as the PMT 204a, may be extracted. The PMT 204a may be found in the next packet (packet 1) based on the extracted PID for the PMT 204a. The PIDs of one or more ESs of the desired program may be extracted from the PMT 204a. The decoding of the one or more ESs of the desired program may start in the next packet (packet 3). Accordingly, signal acquisition and/or channel change may be achieved within three packet durations.

Referring to the actual PSI processing 420, there is shown PSI processing on an actual received MPEG-2 TS. This actual received MPEG-2 TS may be the same MPEG-2 TS used in the ideal PSI processing 410. The actual PSI processing 420 may incorporate inherent delays that may be associated with, for example, PID detection, and/or PID extraction in the PAT 202, and/or the PMT 204a, respectively. In this case, when a PID for the PMT 204a is extracted from the PAT 200 in the packet 0, the packet 1, which may comprise the PMT 204a, may have already passed. Therefore, the de-mux 102 may have to wait for the next PMT 204a packet to occur. In this example, the next PMT 204a packet does not occur until the packet 2501 arrives. By the time the PMT 204a may have been found in the packet 2501 and the PIDs associated with the ESs of the desired program may have been extracted from the PMT 204a, the packet 2502, which may comprise an ES RAP such that the ES RAP 206a may have already passed. Accordingly, the de-mux 102 may have to wait for the next ES RAP 206a packet event in order to start decoding the ESs of the desired program. In this exemplary embodiment of the invention, the next ES RAP 206a may not occur until the packet 5002. It may be easy to see from the actual PSI processing 420 how the delays caused by processing PMT and ES RAP may add additional time to the channel change time or signal acquisition. Specifically, about 5000 packets may have been skipped over before elementary stream decoding may occur compared to the ideal processing 410. This may be unacceptable for some applications, e.g., commercials where advertisers may pay for every second of viewing time.

In accordance with various embodiments of the invention, with reference to the proposed PSI processing 430 for reducing a channel change time or signal acquisition, PSI processing may be done on a gated or buffered MPEG-2 TS. In this case, on signal acquisition or on a channel change, transport data in the received MPEG-2 TS may be first buffered in the TS buffer 314 instead of being passed to the transport engine 320 directly. Exemplary PSI processing such as, for example, PMT PID extraction and ES PID extraction may be performed on the buffered transport data. The transport engine 314 may be initialized using the extracted PSI. The transport data may be fed through the transport engine 314 starting with the buffered data. In this example, it may be assumed that an estimate that delays of about 1000 packets, may be required for the application to perform PMT PID and ES PID extraction, 2500 packets may be initially buffered so no transport data may be lost while performing PSI processing.

As illustrated in the proposed PSI processing 430, the processor 312 may be enabled to detect the PAT 202 over the 2500 buffered packets and extract the PID for the desired PMT such as the PMT 204a. The PMT 204a may be found in the next packet (packet 1) of the packet sequence of the buffered MPEG-2 TS. One or more ES PID associated with the PMT 204a may be extracted from the PMT 204a. Decoding of the one or more ESs in the next packet (packet 2) may start at time instant t1. After the PSI processing, the buffered MPEG-2 TS data may be communicated to the transport engine 320 which may allow decoding starting from the packet 2. In comparison to the ideal PSI processing 410, an overall delay of 2500 packets may be introduced into the system, and this delay may be smaller than the 5000 packet delay seen in the actual PSI processing 420. The inherent 2500 packet delay may not avoid, however, the proposed PSI processing 430, which may eliminate the remaining 2500 packet delay presented in the actual PSI processing 420.

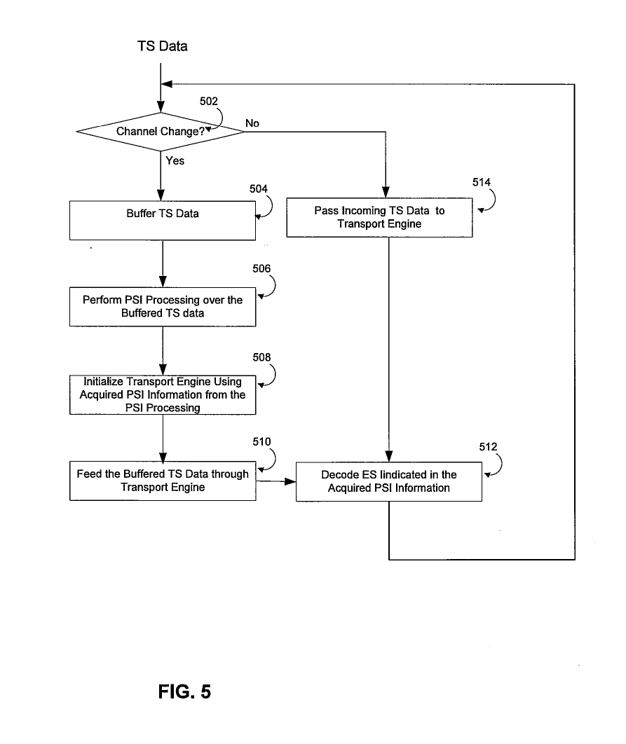

FIG. 5 is an exemplary flow diagram illustrating a PSI processing for fast channel change time, in accordance with an embodiment of the invention. Referring to FIG. 5, the exemplary steps may begin with the step 502 where a MPEG-2 TS may be received using a MPEG-2 decoding system such as the one described with respect to FIG. 1. In step 502, it may be determined whether signal acquisition or a channel change may be required. In instances where signal acquisition or a channel change may be requested, then in step 504, the received MPEG-2 TS data may be buffered in the TS buffer 314. In step 506, PSI processing of the buffered MPEG-2 TS data may be performed as described in the proposed PSI processing 430 in FIG. 4. In step 508, the acquired PSI information may be used to initialize the transport engine 320.

In step 510, the processor 312 in the PSI searcher 310 may communicate the buffered MPEG-2 TS data through the transport engine 320 where it may be split into video, audio, or data components based on the acquired PSI information. In step 512, each individual ES indicated in the acquired PSI information may be decoded, and the next step may be step 502. In step 502, in instances where signal acquisition or a channel change may not be requested, then in step 514, the processor 312 may bypass the TS buffer 314 and communicate the received MPEG-2 TS data directly to the transport engine 320. The next step may be step 512.

Aspects of a method and system for PSI handling to improve channel change time may comprise receiving a MPEG-2 transport bitstream (TS) by the MPEG-2 decoding system 100. The received MPEG-2 TS may comprise the PSI 200, which may be used for acquiring a desired program. In instances where signal acquisition or a channel change may occur, the received MPEG-2 TS may be gated or buffered via the TS buffer 314 in the PSI searcher 310 in order to process at least a portion of the PSI 200 in the received MPEG-2 TS. The processor 312 may perform the PSI detection and extraction in the buffered MPEG-2 TS. After the PSI processing, the buffered MPEG-2 TS may be communicated to the transport engine 320, where it may be split into video, audio, and/or data components based on the extracted PSI. The desired program may be a portion of the buffered MPEG-2 transport bitstream indicated by the extracted PSI, and it may be decoded, accordingly. In instances where signal acquisition or a channel change may not occur, the processor 312 may bypass the TS buffer 314 and communicate the received MPEG-2 TS data directly to the transport engine 320.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for PSI handling to improve channel change time.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of processing data, the method comprising
receiving a bitstream comprising program specific information (PSI);
buffering at least a portion of said received bitstream in response to a detected channel change or signal acquisition; and
processing a portion of said PSI in said buffered at least a portion of said received bitstream to acquire corresponding program content.

2. The method according to claim 1, wherein said received bitstream is a MPEG-2 bitstream.

3. The method according to claim 1, comprising detecting said portion of said PSI in said buffered at least a portion of said received bitstream.

4. The method according to claim 3, comprising extracting said portion of said PSI in said buffered at least a portion of said received bitstream based on said detection.

5. The method according to claim 4, comprising splitting said buffered at least a portion of said received bitstream based on said extracted PSI.

6. The method according to claim 4, comprising decoding a portion of said buffered bitstream into video, audio, and/or data components based on said extracted PSI.

7. The method according to claim 1, comprising bypassing said buffering when said channel change or signal acquisition is not detected.

8. A system of processing data, the system comprising
one or more processors operable to receive a bitstream comprising program specific information (PSI);
said one or more processors are operable to buffer at least a portion of said received bitstream in response to a detected channel change or signal acquisition; and
said one or more processors are operable to process a portion of said PSI in said buffered at least a portion of said received bitstream to acquire corresponding program content.

9. The system according to claim 8, wherein said received bitstream is a MPEG-2 bitstream.

10. The system according to claim 8, wherein said one or more processors are operable to detect said portion of said PSI in said buffered at least a portion of said received bitstream.

11. The system according to claim 10, wherein said one or more processors are operable to extract said portion of said PSI in said buffered at least a portion of said received bitstream based on said detection.

12. The system according to claim 11, wherein said one or more processors are operable to split said buffered at least a portion of said received bitstream based on said extracted PSI.

13. The system according to claim 11, wherein said one or more processors are operable to decode a portion of said buffered bitstream into video, audio, and/or data components based on said extracted PSI.

14. The system according to claim 8, wherein said one or more processors are operable to bypass said buffering when said channel change or signal acquisition is not detected.

15. A machine-readable storage having stored thereon, a computer program having at least one code section for processing data, the at least one code section being executable by a machine for causing the machine to perform steps comprising:
receiving a bitstream comprising program specific information (PSI);
buffering at least a portion of said received bitstream in response to a detected channel change or signal acquisition; and
processing a portion of said PSI in said buffered at least a portion of said received bitstream to acquire corresponding program content.

16. The machine-readable storage according to claim 15, wherein said received bitstream is a MPEG-2 bitstream.

17. The machine-readable storage according to claim 15, wherein said at least one code section comprises code for detecting said portion of said PSI in said buffered at least a portion of said received bitstream.

18. The machine-readable storage according to claim 17, wherein said at least one code section comprises code for extracting said portion of said PSI in said buffered at least a portion of said received bitstream based on said detection.

19. The machine-readable storage according to claim 18, wherein said at least one code section comprises code for splitting said buffered at least a portion of said received bitstream based on said extracted PSI.

20. The machine-readable storage according to claim 18, wherein said at least one code section comprises code for decoding a portion of said buffered bitstream into video, audio, and/or data components based on said extracted PSI.

21. The machine-readable storage according to claim 15, wherein said at least one code section comprises code for bypassing said buffering when said channel change or signal acquisition is not detected.
